(19) United States
(12) Patent Application Publication
(10) Pub. No.: US 2025/0376864 A1
(43) Pub. Date: Dec. 11, 2025

(54) AUTOMATIC SWIMMING POOL CLEANER SYSTEMS WITH IMPROVED END OF CYCLE CONTROL

(71) Applicant: ZODIAC POOL CARE EUROPE, Belberaud (FR)

(72) Inventor: Simon Duffaut, Castelginest (FR)

(73) Assignee: ZODIAC POOL CARE EUROPE, Belberaud (FR)

(21) Appl. No.: 19/230,831

(22) Filed: Jun. 6, 2025

Related U.S. Application Data
(60) Provisional application No. 63/657,242, filed on Jun. 7, 2024.

(51) Int. Cl. E04H 4/16; G05D 1/222; G05D 105/10; G05D 109/30

(52) U.S. Cl. CPC E04H 4/1654; G05D 1/222; G05D 2105/10; G05D 2109/38

(57) ABSTRACT

A self-propelled pool cleaner may be operable in a swimming pool or spa. The self-propelled pool cleaner may identify a removal area in the swimming pool or spa and stop at the removal area. In certain circumstances, the removal area identified by the self-propelled pool cleaner may be in proximity to a waterline of the swimming pool or spa. Optionally, the removal area may be a generally horizontal surface.

### REFERENCE TO RELATED APPLICATION

This application claims the benefit of and priority to U.S. Provisional Patent Application No. 63/657,242, filed on Jun. 7, 2024, and entitled AUTOMATIC SWIMMING POOL CLEANER SYSTEMS WITH IMPROVED END OF CYCLE CONTROL, the content of which is hereby incorporated by reference in its entirety.

### FIELD OF THE INVENTION

The invention relates to self-propelled swimming pool cleaners for cleaning water-containing vessels such as swimming pools and spas and more particularly, although not necessarily exclusively, to systems and methods for improved control of pool cleaners within swimming pools and spas.

### BACKGROUND OF THE INVENTION

Numerous cleaning devices capable of self-propelled movement within swimming pools and spas currently exist. The most common of these devices are self-propelled pool cleaners, which often are either hydraulic or robotic in type. Hydraulic pool cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

While many pool cleaners include cabling or cords extending from the pool cleaner (e.g., to receive power from an external source, communicate with a transmission relay, etc.), some pool cleaners are wireless and omit such cabling. For example, some pool cleaners may include an onboard power source, such as one or more batteries, and/or may include onboard communication modules enabling the pool cleaner to communicate via various wireless communication techniques, thereby eliminating a need for cabling extending from the pool cleaner. Wireless pool cleaners offer several advantages over corded pool cleaners but have their own associated challenges. For example, wireless pool cleaners are not easy to remove from water after an end of a cleaning cycle because there is no cord to pull the pool cleaner out of the water and/or the pool cleaner cannot communicate with a user when the pool cleaner is in the water.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a self-propelled pool cleaner is configured to (i) identify a removal area in a swimming pool or spa and in proximity to a waterline of the swimming pool or spa and (ii) stop at the removal area.

According to various embodiments, a method of controlling a self-propelled pool cleaner includes identifying a removal area within a swimming pool or spa and in proximity to a waterline of the swimming pool or spa and causing an automatic swimming pool cleaner to stop at the removal area.

According to some embodiments, a non-transitory computer readable medium includes program code, which when executed by a processor of a self-propelled pool cleaner is configured to cause the processor to: identify a removal area within a swimming pool or spa and in proximity to a waterline of the swimming pool or spa; and cause the self-propelled swimming pool cleaner to stop at the removal area.

According to certain embodiments, a self-propelled pool cleaner is configured to (i) identify a beach in a swimming pool or spa and (ii) stop at the beach after completing a cleaning cycle.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

FIG. 2 is another view of the pool system of FIG. 1 according to embodiments.

### DETAILED DESCRIPTION

Described herein are systems and methods for improved control of a self-propelled pool cleaner within a swimming pool or spa, particularly to facilitate removal of the pool cleaner from the swimming pool or spa by a user. In some embodiments, the systems and methods described herein may stop the pool cleaner at a removal area within the swimming pool or spa proximate to a waterline of the swimming pool or spa. In various embodiments, the systems and methods described herein may stop the pool cleaner at the removal area responsive to a trigger event, such as but not limited to a completion of a cleaning cycle, a detection of a low power level of onboard batteries, an identified performance issue of the pool cleaner, at a specific time (e.g., as designed by the user), an elapse of a time period, based on input from a user, based on future use or performance, based on a response or indication from the user that the user want to retrieve the pool cleaner (e.g., at any time, and not limited to a completion of the cleaning cycle), and/or as otherwise desired. In various embodiments, the systems and methods described herein may stop the pool cleaner at a removal area in which the user may remove the pool cleaner from the swimming pool or spa without requiring tools.

The removal area may be various areas within the swimming pool or spa and proximate to the waterline, such as but not limited to a beach, a stair, a bench, a sun shelf, and/or other area accessible by a user. In some embodiments, the removal area may be a surface above a floor of the swimming pool or spa, such as a surface between the floor and the waterline. In certain embodiments, the removal area may be a horizontal surface, although it need not be in other embodiments.

The removal area may be received from the user and/or may be determined by the pool cleaner. As a non-limiting example, the pool cleaner may determine and/or detect the removal area based on a starting location of the pool cleaner within the pool (e.g., the starting location is the removal area) As further non-limiting examples, the pool cleaner may determine and/or detect the removal area based on an identification of a surface having a slope, depth, orientation, etc., input parameters from a user, a directional location, a determined geolocation or directional heading relative to an input localized area, a pump current consumption level, a detected pressure, a detected water presence, a detected air presence, a detected change in slope of a surface on which the pool cleaner is travelling, and/or as otherwise desired. In certain embodiments, the pool cleaner may determine and/or detect the removal area by climbing one or more walls until a detected characteristic (e.g., energy consumption, localized area, pressure level, water presence level, air presence level, etc.) is at or within tolerances of a threshold corresponding to the removal area. Optionally, at the removal area, the pool cleaner may further orient itself to present the handle in a desired direction (e.g., to facilitate handle access to the user). As a non-limiting example, the pool cleaner may orient itself such that a handle extends towards or above the waterline.

The pool cleaner stopping at the removal area may facilitate removal of the pool cleaner from the swimming pool or spa. The systems and methods described herein may be useful for various pool cleaners, and may be particularly useful with wireless pool cleaners. Various other benefits and advantages may be realized with the systems, devices, and methods provided herein, and the aforementioned advantages should not be considered limiting.

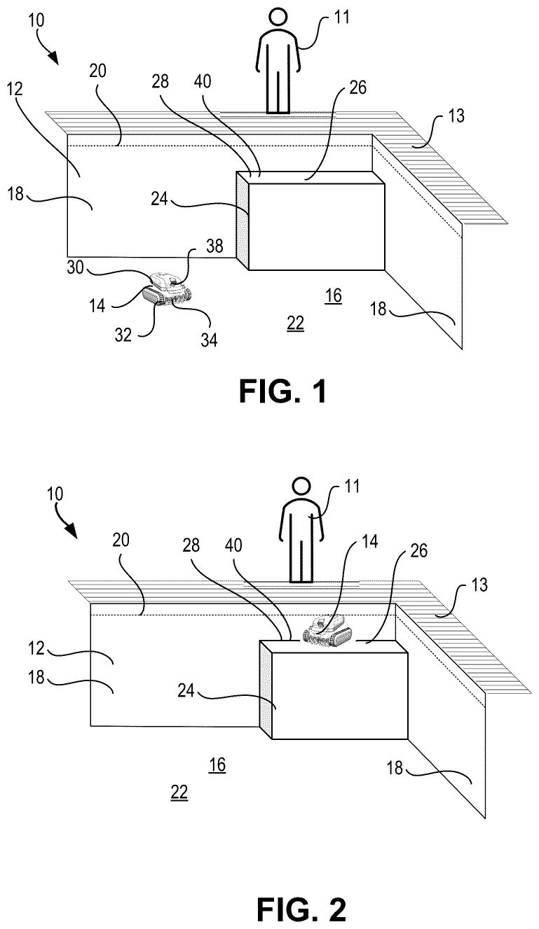

FIGS. 1 and 2 illustrate an example of a pool system 10 according to embodiments. The pool system 10 generally includes a swimming pool or spa (hereinafter “pool 12”) and a pool cleaner 14.

The pool 12 may have various shapes, sizes, and/or profiles as desired, but generally includes a floor 16 and one or more walls 18. A distance from a waterline 20 of water 22 within the pool 12 to the floor 16 may be a maximum depth of the water 22.

In certain embodiments, the pool 12 may include various features or objects 24 having one or more surfaces 26 elevated above the floor 16 and/or more proximate to an exterior surface 13 (e.g., of a pool deck) that a user 11 may be on. Optionally, the one or more surfaces 26 are between the floor 16 and the waterline 20 when the pool 12 is filled with water 22. Such objects 24 may include, but are not limited to, a beach 28, one or more stairs, a bench, a sun shelf, combinations thereof, and/or other objects or features as desired. In the embodiment illustrated in FIG. 1, the object 24 is the beach 28 having the surface 26, and as illustrated, the surface 26 is more proximate to the waterline 20 than the floor 16. In other embodiments, the surface 26 may be at any desired elevation relative to the floor 16. In some embodiments, at least one surface 26 may be generally horizontal, although it need not be in other embodiments. As a non-limiting example, the surface 26 may be sloped relative to the floor 16 while at an elevation above the floor 16. As another non-limiting example, the surface 26 may extend from the floor 16 towards the waterline 20. Moreover, while the beach 28 is illustrated as rectangular or box-like, in other embodiments, the beach 28 and/or other objects 24 may have other shapes or profiles as desired with surfaces 26 more proximate to the waterline 20 than the floor 16.

As illustrated in FIG. 1, the pool cleaner 14 generally includes a body 30, one or more motive elements 32, and one or more cleaning devices 34 (including but not limited to a scrubber brush). A motor, pump, filter, and various other features may be provided on or within the pool cleaner 14 as desired. Optionally, the pool cleaner 14 includes one or more handles 38 which may be utilized by the user 11 to handle the pool cleaner 14. As non-limiting examples, the handle 38 may be used for carrying the pool cleaner 14, lifting the pool cleaner 14, combinations thereof, and/or otherwise handling the pool cleaner 14 as desired. In certain embodiments, the pool cleaner 14 includes an on-board power source, such as but not limited to one or more on-board batteries. In certain embodiments, and as illustrated in FIG. 1, the pool cleaner 14 may be a wireless pool cleaner omitting external cabling or cords connecting the pool cleaner 14 to other devices. However, in other embodiments, the pool cleaner 14 may be a corded pool cleaner. Non-limiting examples of pool cleaners 14 may include those described in U.S. Pat. Nos. 10,316,534, 9,488,154, 8,578,538, and U.S. Patent Publication No. 2014/0303810, all of which are hereby incorporated by reference in their entireties.

In various embodiments, the pool cleaner 14 includes an onboard controller or control system, which may include one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the pool cleaner 14 (e.g., via control by the controller) may perform various operations to facilitate removal of the pool cleaner 14 from the pool 12 by the user 11. As explained in greater detail below, in various embodiments, the pool cleaner 14 may identify one or more removal areas 40 in the pool 12 and selectively stop itself at the one or more removal areas 40.

The removal areas 40 within the pool 12 may be various locations and/or surfaces within proximity of the waterline 20. In certain embodiments, the one or more removal areas 40 are locations at which the user 11 may access and/or remove the pool cleaner 14 from the pool 12 without requiring the use of a tool (e.g., a lift, lever, trolley, etc.). Non-limiting examples of removal areas 40 include the surfaces 26 of the objects 24 that are elevated above the floor 16. As non-limiting examples, the removal areas 40 may include the beach 28, one or more steps, a sun shelf, and/or a bench, combinations thereof, and/or otherwise as desired. In some embodiments, the removal areas 40 are generally horizontal surfaces (e.g., extending more horizontal than vertical), although they need not be in other embodiments.

In some embodiments, the removal areas 40 may be predefined. As a non-limiting example, the user 11 may supply the pool cleaner 14 with a localized area within the pool 12 defined as the removal area 40. As a non-limiting example, the predefined removal area 40 may be identified by a geolocation and/or directional indicator. In such embodiments, the user 11 may provide the input to the pool cleaner 14 via an interface on the pool cleaner 14 and/or by wired or wirelessly communications with the pool cleaner 14 from a remote device. As a further non-limiting example, the removal area 40 may be predefined based on a prior identification and recordation of the removal area 40 within the pool 12. As a non-limiting example, the pool cleaner 14 and/or user may identify the beach 28 as the removal area 40 based on a previous identification of the beach 28 as the removal area 40 and/or based on a previous removal of the pool cleaner 14 by the user 11 from the beach 28.

Additionally, or alternatively, the removal areas 40 may be identified by the pool cleaner 14. In such embodiments, the pool cleaner 14 may utilize various techniques or mechanisms to identify a particular area of the pool as a removal area 40. In such embodiments, because desired removal areas 40 are in proximity to the waterline 20, the pool cleaner 14 may identify an area as the removal area 40 by sensing and/or measuring one or more characteristics of the pool cleaner 14 that change based on proximity to the waterline 20. In some embodiments, the sensed or measured characteristics may be compared to one or more thresholds to identify a removal area 40, although other techniques may be utilized as desired. Non-limiting examples of sensed or measured characteristics used to identify a removal area 40 are discussed below, but various other characteristics may be utilized as desired. Moreover, such characteristics may be utilized in various combinations as desired to identify one or more removal areas 40.

As one non-limiting example, the pool cleaner 14 may identify a particular area as a removal area 40 based on an energy consumption of one or more components of the pool cleaner 14, such as but not limited to current consumption of a pump of the pool cleaner 14. In this example, when the pool cleaner 14 is in proximity to the waterline 20, air in the pump may disrupt and/or otherwise change operation of the pump, thereby changing energy consumption of the pump.

As another non-limiting example, the pool cleaner 14 may identify a particular area as a removal area 40 based on a detected pressure and/or detected depth. In such embodiments, the pool cleaner 14 optionally includes an onboard pressure sensor, and the pool cleaner 14 may identify an area as a removal area 40 when the measured pressure is at or exceeds a threshold pressure.

As a further non-limiting example, the pool cleaner 14 may identify a particular area as a removal area 40 based on a detection of a presence of water and/or a presence of air. As an example, the pool cleaner 14 may identify the removal area 40 based on the absence of water and/or the presence of air. Various suitable sensors may be utilized as the water detection sensor and/or the air presence sensor.

As yet another non-limiting example, the pool cleaner 14 may identify a particular area as a removal area 40 based on a detected slope and/or a change in slope of the surface on which the pool cleaner 14 is moving. As a non-limiting example, the pool cleaner 14 may identify the removal area 40 based on a direction of travel of the pool cleaner 14 being generally horizontal and/or changing from generally vertical (e.g., more vertical than horizontal) to generally horizontal. Various suitable sensors may be utilized to detect a change in slope, such as but not limited to an accelerometer, gyroscope, tilt sensor, etc.

As mentioned, various other techniques (and combinations thereof) may be utilized by the pool cleaner 14 to identify one or removal areas 40, and the aforementioned examples should not be considered limiting.

The pool cleaner 14 may navigate toward the removal area 40 and stop itself at the removal area 40 selectively and/or responsive to various trigger events as desired. As non-limiting examples, the pool cleaner 14 may stop itself at the removal area 40 after a completion of a cleaning cycle, based on a detection of a low power level of onboard batteries, based on an identified performance issue of the pool cleaner, based on input from a user, based on a response or indication from the user that the user wants to retrieve the pool cleaner, combinations thereof, and/or as otherwise desired. In embodiments with the trigger event, the pool cleaner 14 may identify the removal area 40 prior to the triggering event and/or after the triggering event as desired. As a non-limiting example, the pool cleaner 14 may identify the removal area 40 before the completion of a cleaning cycle as the trigger event or after the completion of the cleaning cycle. Other combinations may be utilized as desired.

In embodiments where the removal area 40 is input from the user, the pool cleaner 14 may navigate to the removal area 40 using various navigation and/or location service techniques, such as but not limited to a compass, GPS, gyroscope, and/or accelerometer. In embodiments where the pool cleaner 14 identifies and determines the removal area 40, the pool cleaner 14 may navigate within the pool pursuant to one or more navigation patterns, such as by climbing each wall 18 until the pool cleaner 14 identifies the object 24 and/or surface 26 of the object 24 and/or other removal area 40 as desired.

Optionally, at the removal area 40, the pool cleaner 14 may further orient itself to further facilitate removal by the user 11. As a non-limiting example, the pool cleaner 14 may orient itself at the removal area 40 such that the handle 38 is at a desired direction or orientation to facilitate handle access. In one non-limiting example, the pool cleaner 14 may orient itself at the removal area 40 such that the handle 38 extends towards and/or above the waterline 20. In some embodiments, the pool cleaner 14 may orient itself at the removal area 40 such that it is arranged in a horizontal position; however, it need not orient itself to be horizontal in other embodiments.

A method of controlling the pool cleaner 14 (e.g., implemented by the controller) may include identifying one or more removal areas 40 within the pool 12 and in proximity to the waterline 20 and selectively causing the pool cleaner 14 to stop at the one or more removal areas 40. In certain embodiments, the method includes causing the pool cleaner 14 to stop at the one or more removal areas 40 responsive to a trigger event, such as but not limited to a completion of a cleaning cycle.

In some embodiments, the method includes identifying at least one of a beach, a step, a sun shelf, and/or a bench as removal areas 40, and in one non-limiting example the method includes identifying the beach 28 as the removal area 40. Optionally, the method includes identifying a surface above the floor 16 as the removal area 40, such as but not limited to a horizontal surface.

In various embodiments, the method includes identifying the one or more removal areas 40 based on input from the user. Additionally, or alternatively, the method includes identifying the one or more removal areas 40 based on one or more measured or detected characteristics, such as but not limited to a detected or measured pump current consumption, a detected or measured pressure, a detected or measured water presence, a detected or measured air presence, and/or a detected or measured incline of a surface on which the pool cleaner 14 is travelling. Optionally, the method includes causing the pool cleaner 14 to orient itself to present the handle 38 of the self-propelled pool cleaner towards or above the waterline.

As mentioned, the systems and methods described herein may facilitate removal of the pool cleaner 14 from the pool 12 by the user 11. In certain embodiments, the systems and methods described herein may allow for removal of the pool cleaner 14 from the pool 12 without the use of tools. The systems and methods may facilitate removal of various pool cleaners 14, and may particularly facilitate removal of wireless pool cleaners 14.

Exemplary concepts or combinations of features of the invention may include, but are not limited to:
A. A self-propelled pool cleaner configured to (i) identify a removal area in a swimming pool or spa and in proximity to a waterline of the swimming pool or spa and (ii) stop at the removal area.
B. The self-propelled pool cleaner of any preceding or subsequent statement or combination of statements, wherein the self-propelled pool cleaner is configured to stop at the removal area in response to a trigger event.
C. The self-propelled pool cleaner of any preceding or subsequent statement or combination of statements, wherein the trigger event comprises a completion of a cleaning cycle, a detection of a low power level of onboard batteries, an identified performance issue of the pool cleaner, input from a user, and/or a response or indication from the user that the user want to retrieve the pool cleaner.
D. The self-propelled pool cleaner of any preceding or subsequent statement or combination of statements, wherein the self-propelled pool cleaner is configured to identify the removal area based on input from a user.
E. The self-propelled pool cleaner of any preceding or subsequent statement or combination of statements, wherein the input comprises a localized area with a directional indicator, and wherein the self-propelled pool cleaner is configured to navigate to the localized area using a location service.
F. The self-propelled pool cleaner of any preceding or subsequent statement or combination of statements, wherein the location service comprises an onboard compass, GPS, gyroscope, or accelerometer.
G. The self-propelled pool cleaner of any preceding or subsequent statement or combination of statements, wherein the self-propelled pool cleaner is configured to identify the removal area.
H. The self-propelled pool cleaner of any preceding or subsequent statement or combination of statements, wherein the removal area is on at least one of a beach of the swimming pool or spa, a stair of the swimming pool or spa, a sun shelf of the swimming pool or spa, or a bench of a swimming pool or spa.
I. The self-propelled pool cleaner of any preceding or subsequent statement or combination of statements, wherein the removal area comprises a surface of the swimming pool or spa between a floor of the swimming pool or spa and the waterline.
J. The self-propelled pool cleaner of any preceding or subsequent statement or combination of statements, wherein the removal area comprises a horizontal surface between a floor of the swimming pool or spa and the waterline.
K. The self-propelled pool cleaner of any preceding or subsequent statement or combination of statements, wherein the removal area is a beach.
L. The self-propelled pool cleaner of any preceding or subsequent statement or combination of statements, wherein the self-propelled pool cleaner is configured to identify the removal area based on a detected or measured characteristic such as pump current consumption, pressure, presence of water, and/or presence of air.
M. The self-propelled pool cleaner of any preceding or subsequent statement or combination of statements, wherein the self-propelled pool cleaner is further configured to compare the detected or measured pump current consumption, pressure, presence of water, and/or presence of air with one or more thresholds to identify the removal area.
N. The self-propelled pool cleaner of any preceding or subsequent statement or combination of statements, wherein the self-propelled pool cleaner is further configured to record a localization of the removal area.
O. The self-propelled pool cleaner of any preceding or subsequent statement or combination of statements, wherein the removal area is an area in which a user may remove the self-propelled pool cleaner without a removal tool.
P. The self-propelled pool cleaner of any preceding or subsequent statement or combination of statements, wherein the self-propelled pool cleaner is further configured to orient itself at the removal area to present a handle of the self-propelled pool cleaner in a desired direction.
Q. The self-propelled pool cleaner of any preceding or subsequent statement or combination of statements, wherein the self-propelled pool cleaner is configured to identify the removal area by climbing one or more walls of the swimming pool or spa until the removal area is detected by detecting at least one of a change is pump current consumption, a change in pressure, a change in water presence, a change in air presence, a change in slope of the surface on which the self-propelled pool cleaner is moving, or a geolocation.
R. The self-propelled pool cleaner of any preceding or subsequent statement or combination of statements, wherein the self-propelled pool cleaner comprises a processor and a memory coupled to the processor.
S. The self-propelled pool cleaner of any preceding or subsequent statement or combination of statements, wherein the self-propelled pool cleaner is configured to stop at the removal area based on one or more of an end of a cleaning cycle, an elapse of a time period, a specific time, a designation or input from a user, a starting location, a power level of a battery, a performance issue, a scheduled use, combinations thereof, and/or as otherwise desired.
T. A method comprising identifying a removal area within a swimming pool or spa and in proximity to a waterline of the swimming pool or spa and causing an automatic swimming pool cleaner to stop at the removal area.
U. The method of any preceding or subsequent statement or combination of statements, wherein identifying the removal area comprises identifying at least one of a beach, a stair, or a bench.
V. The method of any preceding or subsequent statement or combination of statements, wherein identifying the removal area comprises identifying a horizontal surface above a floor of the swimming pool or spa.
W. The method of any preceding or subsequent statement or combination of statements, wherein identifying the removal area is based on input from a user.
X. The method of any preceding or subsequent statement or combination of statements, wherein identifying the removal area is based on a detected or measured characteristic such as pump current consumption, pressure, water presence, air presence, and/or incline of a surface on which the self-propelled pool cleaner is travelling.
Y. The method of any preceding or subsequent statement or combination of statements, wherein stopping at the removal area is after a completion of a cleaning cycle or in response to input from a user.
Z. The method of any preceding or subsequent statement or combination of statements, further comprising causing the self-propelled pool cleaner to orient itself to present a handle of the self-propelled pool cleaner towards or above the waterline.
AA. The method of any preceding or subsequent statement or combination of statements, wherein causing an automatic swimming pool cleaner to stop at the removal area is based on one or more of an end of a cleaning cycle, an elapse of a time period, a specific time, a designation or input from a user, a starting location, a power level of a battery, a performance issue, a scheduled use, combinations thereof, and/or as otherwise desired
BB. A non-transitory computer readable medium comprising program code, which when executed by a processor is configured to cause the processor to:
   i. identify a removal area within a swimming pool or spa and in proximity to a waterline of the swimming pool or spa; and
   ii. cause an automatic swimming pool cleaner to stop at the removal area.
CC. Non-transitory computer readable medium comprising program code, which when executed by a processor is configured to cause the processor to perform the method of any preceding or subsequent statement or combination of statements.
DD. A self-propelled pool cleaner configured to (i) identify a beach in a swimming pool or spa and (ii) stop at the beach after completing a cleaning cycle.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although devices and techniques are described for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A self-propelled pool cleaner comprising a control system, wherein the self-propelled pool cleaner is configured to (i) identify a removal area in a swimming pool or spa and in proximity to a waterline of the swimming pool or spa and (ii) stop at the removal area.

2. The self-propelled pool cleaner of claim 1, wherein the self-propelled pool cleaner is configured to stop at the removal area in response to a trigger event.

3. The self-propelled pool cleaner of claim 2, wherein the trigger event comprises a completion of a cleaning cycle, a detection of a low power level of onboard batteries, an identified performance issue of the pool cleaner, input from a user, and/or a response or indication from the user that the user want to retrieve the pool cleaner.

4. The self-propelled pool cleaner of claim 1, wherein the self-propelled pool cleaner is configured to identify the removal area based on input from a user.

5. The self-propelled pool cleaner of claim 4, wherein the input comprises a localized area with a directional indicator, and wherein the self-propelled pool cleaner is configured to navigate to the localized area using a location service.

6. The self-propelled pool cleaner of claim 1, wherein the self-propelled pool cleaner is configured to identify the removal area.

7. The self-propelled pool cleaner of claim 1, wherein the removal area is a generally horizontal surface of the swimming pool or spa between a floor of the swimming pool or spa and the waterline.

8. The self-propelled pool cleaner of claim 1, wherein the self-propelled pool cleaner is configured to identify the removal area based on a detected or measured characteristic such as pump current consumption, pressure, presence of water, and/or presence of air.

9. The self-propelled pool cleaner of claim 1, wherein the self-propelled pool cleaner is further configured to orient itself at the removal area to present a handle of the self-propelled pool cleaner in a desired direction.

10. The self-propelled pool cleaner of claim 1, wherein the self-propelled pool cleaner is configured to identify the removal area by climbing one or more walls of the swimming pool or spa until the removal area is detected by detecting at least one of a change is pump current consumption, a change in pressure, a change in water presence, a change in air presence, a change in slope of the surface on which the self-propelled pool cleaner is moving, or a geolocation.

11. The self-propelled pool cleaner of claim 1, wherein the self-propelled pool cleaner is configured to stop at the removal area based on one or more of an end of a cleaning cycle, an elapse of a time period, a specific time, a designation or input from a user, a starting location, a power level of a battery, a performance issue, a scheduled use, combinations thereof, and/or as otherwise desired.

12. A method of controlling a self-propelled pool cleaner, the method comprising:
identifying, by the self-propelled pool cleaner, a removal area within a swimming pool or spa and in proximity to a waterline of the swimming pool or spa; and
causing the self-propelled pool cleaner to stop at the removal area.

13. The method of claim 12, wherein identifying the removal area comprises identifying a generally horizontal surface above a floor of the swimming pool or spa.

14. The method of claim 12, wherein identifying the removal area is based on a detected or measured characteristic such as pump current consumption, pressure, water presence, air presence, and/or incline of a surface on which the self-propelled pool cleaner is travelling.

15. The method of claim 12, wherein stopping at the removal area is after a completion of a cleaning cycle or in response to input from a user.

16. The method of claim 12, further comprising causing the self-propelled pool cleaner to orient itself to present a handle of the self-propelled pool cleaner towards or above the waterline.

17. The method of claim 12, wherein causing an automatic swimming pool cleaner to stop at the removal area is based on one or more of an end of a cleaning cycle, an elapse of a time period, a specific time, a designation or input from a user, a starting location, a power level of a battery, a performance issue, a scheduled use, combinations thereof, and/or as otherwise desired.

18. A self-propelled pool cleaner comprising a control system, wherein the self-propelled pool cleaner is configured to (i) identify a beach in a swimming pool or spa and (ii) stop at the beach after completing a cleaning cycle.

19. The self-propelled pool cleaner of claim 18, wherein the self-propelled pool cleaner is configured to identify the beach by climbing one or more walls of the swimming pool or spa until the beach is detected by detecting at least one of a change is pump current consumption, a change in pressure, a change in water presence, a change in air presence, a change in slope of the surface on which the self-propelled pool cleaner is moving, or a geolocation.

20. The self-propelled pool cleaner of claim 18, wherein the self-propelled pool cleaner is configured to orient itself to present a handle of the self-propelled pool cleaner towards or above the waterline.
